(19) United States
(12) Patent Application Publication
(10) Pub. No.: US 2021/0383038 A1
(43) Pub. Date: Dec. 9, 2021

(54) METHOD FOR THE THEORETICAL ANALYSIS OF A PROCESS APPARATUS THROUGH WHICH FLUID FLOWS

(71) Applicant: Linde GmbH, Pullach (DE)

(72) Inventors: Reinhold HÖLZL, Geretsried (DE); Alexander WOITALKA, München (DE)

(21) Appl. No.: 17/288,145

(22) PCT Filed: Oct. 10, 2019
(86) PCT No.: PCT/EP2019/025340

§ 371 Date: Apr. 23, 2021

(30) Foreign Application Priority Data
Oct. 26, 2018 (EP) 18020558.5

(51) Int. Cl. G06F 30/23

(52) U.S. Cl. CPC G06F 30/23; G06F 2111/10

(57) ABSTRACT

The present invention relates to a method for the theoretical analysis of a process apparatus through which fluid flows, wherein a theoretical, in particular numerical simulation of the apparatus or of at least one part of the apparatus is carried out, wherein at least one element of the apparatus which does not comprise concrete as a material is replaced in the theoretical simulation by at least one concrete element which is manufactured from concrete, and wherein a load analysis of the apparatus is carried out with the aid of the theoretical simulation.

The invention relates to a method for theoretical analysis of a process apparatus through which fluid flows and also to a computing unit and a computer program for carrying out such method.

### PRIOR ART

Process plants are usually understood to mean plants for effecting substance changes and/or substance conversions with the aid of purpose-oriented, physical and/or chemical and/or biological and/or nuclear action flows. Such changes and conversions typically include crushing, sieving, mixing, heat transfer, rectification, crystallization, drying, cooling, filling, and superimposed substance conversions, such as chemical, biological, or nuclear reactions. Process apparatuses through which fluid flows, such as, for example, vacuum-soldered (aluminum) plate fin heat exchangers (PFHE) or coil-wound heat exchangers (CWHE) are often used in process plants because of a large number of advantages (heat integration, compactness, costs).

Such apparatuses can be simulated and examined theoretically by means of numerical models or simulations—usually, a finite element method. In this way, for example, various design variants can be tested and examined for improvement potential in the course of a planning or design phase of the apparatus, before its construction and commissioning. The apparatus can also already be commissioned, for example, and, with the aid of such simulations, the ongoing operation of the apparatus can be monitored or its future development can be examined—for example, in order to be able to detect indicated damage.

In these simulations, it has been found that, in particular, the contact points of adjacent bodies, e.g., between fins and plates of a PFHE or between adjacent tubes of a CWHE, represent partially insurmountable obstacles. Namely, in the case of an FEM having more than one body (assembled structure), there is a possibility of body contact due to deformation. So-called finite contact elements are used to treat the mechanical effects occurring during this process, such as impact effects, interfacial deformations, adhesion, friction, or, again, separation of the bodies as a result of body contact.

Contact elements are usually used to computationally detect the body contact and the transmission of the forces occurring in the process. Since the nature of this calculation is non-linear, convergence problems and computational terminations are often the result. In particular, the insoluble problem arises here that the contact tolerances should ideally be in the range of a few micrometers for acceptable accuracy, but the deformations of the process apparatus, as a result of the large masses, lie in the range of millimeters. This leads to hurdles in the course of the computational simulations which cannot be overcome.

### DISCLOSURE OF THE INVENTION

Against this background, the present invention proposes a method for the theoretical analysis of a process apparatus through which fluid flows, and also a computing unit and a computer program for carrying out the same, having the features of the independent claims. Advantageous embodiments are the subject matter of the dependent claims and the following description.

The process apparatus through which fluid flows can, in particular, be designed as a heat exchanger—in particular, as a plate heat exchanger or coil or wound heat exchanger. Furthermore, it is also conceivable for the apparatus to be embodied, in particular, as a column (hollow, slender column with fittings) or as a phase separator (container with fittings). In particular, the apparatus features at least two bodies that are in contact.

Within the scope of the method, a theoretical—in particular, numerical—simulation of the apparatus or at least one part of the apparatus is carried out. In the theoretical simulation, at least one element of the apparatus which features no concrete as a material is replaced or represented by at least one concrete element manufactured from concrete, and a load analysis of the apparatus is carried out with the aid of the theoretical simulation.

The simulation can be created and carried out, for example, in the course of a planning or design phase, before the apparatus is built and commissioned—for example, in order to test and examine a dimensioning or design specifications of the planned apparatus. It is also conceivable for the apparatus to have already been commissioned and for the running operation of the apparatus to be monitored with the aid of the simulation, or for its future development to be examined—for example, in order to be able to detect indicated damage early.

In the course of load analysis, the behavior of the apparatus under load, in particular, is examined Such stresses can occur, for example, during the operation of the apparatus—for example, due to the temperature and pressure changes acting on the apparatus. Likewise, these may, expediently, be loads which occur when the apparatus is out of operation and not being driven, e.g., mechanical loads experienced by the apparatus as a result of its own weight, such as mechanical stresses, deformations, strains, etc.

In the context of the present invention, it has now been recognized that specific elements of the apparatus which are produced from a material other than concrete—in particular, from a metal such as solder or soldering agent, and, in particular, on soldered connections—or steel or aluminum—in particular, on welded connections—can be approximated or simulated in the theoretical simulation by concrete elements manufactured from concrete, since such a concrete element or concrete as material generally has properties comparable to metallic contact points with regard to forces and force transmission occurring at contact points.

Concrete and the concrete elements have—in particular, per se—those behavioral properties with regard to loads which are to be simulated in the theoretical simulation for the corresponding elements—in particular, with regard to a body contact. Simulation or calculation of corresponding forces and force transmission in concrete elements is, expediently, not found to be problematic for numerical computational methods.

By replacing corresponding elements of the apparatus with concrete elements, it is now made possible to be able to calculate the load in a body of the apparatus—in particular, deformations or expansions due to forces or force transmissions occurring upon contact with another body—without causing convergence problems, computational terminations, or even insoluble problems for the simulation and its algorithms. The invention thus enables a reliable theoretical analysis of the process apparatus through which fluid flows.

The at least one element is, advantageously, at least one contact element, by means of which forces are transmitted between two adjacent elements. In particular, the at least one contact element is not physically separate from the adjacent elements, but is in physical connection directly therewith. In particular, each of the adjacent elements is part of different bodies, which exchange forces by means of the contact element and, in particular, touch or are connected. For example, the apparatus for the theoretical simulation can be divided conceptually into its components (bodies), wherein each component is in turn subdivided into various small elements, wherein any contact points between the components are simulated by means of contact elements. Contact elements, which therefore transmit forces between adjacent bodies—in particular, forces or their transmissions which can lead to deformations or strains—are, expediently, simulated as corresponding concrete elements.

In a preferred embodiment, the at least one element and the at least one concrete element have the same or at least substantially the same properties with regard to force transmission to adjacent elements. The same or at least substantially the same properties should be understood in this context to mean, in particular, that a force difference for the at least one element and a force difference for the at least one concrete element differ by no more than a predetermined value—in particular, no more than 5% max., furthermore, in particular, 3% max., and, more particularly, 1% max. This force difference is to be understood, in particular, as a difference between a force acting on the respective element or concrete element and a force acting on its adjacent element.

In particular, properties of the element and of the corresponding concrete element, which are important for the load analysis, are thus comparable with one another. By replacing the respective element with the corresponding concrete element, the behavior of the apparatus under force effects can, expediently, be examined during the course of the theoretical simulation—in particular, at what forces a break, a defect, or an opening of the apparatus occurs. In particular, in the case of both the element and the corresponding concrete element, a break, a defect, or an opening occurs in each case at the same or at least substantially the same force transmission, wherein, here too, these force transmissions differ by not more than a predetermined value—in particular, not more than 5% max., furthermore, in particular, 3% max., and, more particularly, 1% max.

The at least one concrete element preferably has the property of transmitting compressive forces completely or at least substantially completely to at least one adjacent element. In particular, compressive forces are transmitted from the concrete element at at least 95%, preferably at least 97%, and more preferably at least 99%. Thus, compressive forces from the concrete element, such as, in particular, also from the corresponding replaced element, are transmitted completely and, in particular, have no or at least hardly any share in a breakage or opening of the apparatus.

Particularly preferably, the at least one concrete element has the property of transmitting tensile forces to at least one adjacent element up to a predeterminable threshold value. In contrast to compressive forces, tensile forces are thus, in particular, not transmitted completely and unimpeded, but only up to the threshold value, which, in the simulation, can be set and varied, in particular, as an input parameter. In particular, the simulated transmission characteristic of tensile forces of the concrete element can thus be adapted to the corresponding property of the respective replaced element.

Advantageously, the predeterminable threshold value represents a breakage of the apparatus. Breakage is to be understood, in particular, as damage which can lead to failure of the apparatus and to maintenance, repair, or replacement of parts, which in turn can be associated with additional costs. Such a breakage can, preferably, be an opening of a structure, e.g., a crack formation, a lifting of an element from an adjacent element originally connected thereto, the loosening of a connection, such as a weld, solder, or screw connection, etc.

In particular, with the aid of the concrete elements and the threshold value, it is thus possible to simulate different materials with different tensile force transmission properties for the corresponding replaced element and to examine their behavior in the apparatus—in particular, as to whether and, if so, when there is breakage due to the use of these materials. Thus, for example, in the course of a planning and design phase of the apparatus, various designs or structural variants of the apparatus can be tested and, in particular, examined for improvement potential, in order to allow the apparatus to operate as error-free as possible, without undesired, cost-intensive breakages occurring.

Depending upon the selection of the element to be replaced, as well as the replacing concrete element and the respective threshold value, load analyses can be simulated with the aid of the simulation at different locations—in particular, those susceptible to breakages—as will be explained below with reference to three, particularly preferred embodiments.

The at least one element is, advantageously, part of a flange or a flange connection—in particular, a flange seal. In the simulation, this part of the flange—in particular, the part made of metal, e.g., steel or aluminum—is, expediently, replaced by an adequate element made of concrete. Advantageously, the predeterminable threshold value represents a leakage of a flange seal. For tightness, such a flange connection requires, in particular, a certain surface pressure—in particular, by means of compressive forces. If this is undershot or eliminated, a leakage can be assumed. Due to the concrete elements, it is possible to compute this state simply, precisely, and quickly. In particular, a surface pressure distribution over the flange seal can be analyzed in the course of the simulation. Due to an inclination of the flange sealing surfaces, only, for example, the outer region of the seal can be pressed, as a result of which the entire force distribution can change, which in turn can have effects on the tightness of the flange. This is also easy to simulate and analyze due to the concrete elements.

In a preferred embodiment, the apparatus is designed as a plate heat exchanger—in particular, as a vacuum-soldered (e.g., aluminum) plate fin heat exchanger (PFHE). In this case, the at least one element is preferably part of a connection of bodies of the plate heat exchanger—preferably part of a soldered connection. Such a soldered connection can, in particular, be between a plate or a separating plate and a profile or a fin.

The predeterminable threshold value, advantageously, represents an opening or separation of separating plates and profiles of the apparatus embodied as a plate heat exchanger. During soldering of plate heat exchangers, an uneven temperature distribution within a block of the plate heat exchanger can often occur during heating or cooling. Due to different thermal expansions and resulting deformation differences, this can lead to gap formations within the block due to the loose or insufficiently firmly connected separating plates and profiles. This can lead to problems in the area of the insufficiently soldered separating plates and profiles. With the aid of the theoretical simulation, such cases of breakage can be examined sufficiently in the course of the load analysis, e.g., in order to avoid such errors during soldering in the course of the manufacturing process of the plate heat exchanger, or to improve insufficiently soldered points, for example.

Advantageously, the apparatus can be designed as a coil-wound heat exchanger (CWHE). In this case, the at least one element is preferably part of a connection between tubes of a bundle of the heat exchanger, which, in particular, comprises a plurality of individual tubes or lines. Furthermore, the at least one element is preferably part of a bundle end—more preferably, a free-hanging bundle end. The individual tubes of a bundle are wound—for example, spirally—around a core or core tube in such a heat exchanger. At their ends, the individual tubes can each be connected to an end plate—for example, welded or soldered. At the bundle end, the plurality of tubes is often no longer supported, e.g., no longer stiffened by support arms, and mostly hangs freely between the core tube and the end plate.

The predeterminable threshold value, advantageously, represents an opening of a bundle—in particular, at a bundle end of the apparatus embodied as a coil or wound heat exchanger. Such opening can occur, in particular, due to the bending of the bundle under its own weight. In the manufacturing process of such a heat exchanger, the bundle may be opened when the tubes are wound around the core tube, due to frequent rotation in conjunction with sagging at the free bundle end. Consequently, tearing off of brackets and resulting possible tube damage can result in the course of manufacture. In this case as well, with the aid of the theoretical simulation, such cases of breakage can be examined sufficiently and avoided or appropriately improved during the manufacturing process.

It goes without saying that the apparatus can also be designed in an alternative, expedient manner—for example, as a column or container for phase separation. It is essential only that contact points exist between bodies of the apparatus and that these be modeled by means of the concrete elements. In particular, the method is particularly suitable for contact points in which a separation, an opening, or a breakage can be established.

In a preferred embodiment, a tension, deformation, and/or temperature field analysis of the apparatus is carried out as a load analysis. In particular, respective mechanical stresses, deformations or expansions, and/or distribution of the temperature field within the apparatus can thus be examined—furthermore, in particular, between the at least one element and its neighboring elements, and, further, in particular, between all elements of the apparatus. Particularly preferably, in the course of the load analysis, a behavior of the apparatus under load up until a breakage occurs is examined

Preferably, a finite element method is carried out as the theoretical simulation of the apparatus or at least of the part of the apparatus. The finite element method (FEM) is a numerical method based upon the numerical solution of a complex system of partial differential equations. Thereby, the apparatus is divided into a finite number of sub-regions of simple shape, i.e., into finite elements whose physical or thermo-hydraulic behavior can be calculated on the basis of their simple geometry. In each of the finite elements, the partial differential equations are replaced by simple differential equations or by algebraic equations. The system of equations thus obtained is solved in order to obtain an approximate solution of the partial differential equations. During the transition from one element into the adjacent element, the physical behavior of the entire body is simulated by predetermined continuity conditions. This is known and widespread in principle, and solutions available on the market can be used for this purpose. In the context of the present invention, however, at least one finite element of these finite elements—in particular, a finite contact element—is now represented by at least one concrete element.

A computing unit according to the invention, e.g., a control device of an apparatus, is designed—in particular, in terms of programming—to carry out a method according to the invention.

The implementation of the invention in the form of software is also advantageous, since this makes particularly low costs possible—particularly if an executing computing unit is used for further tasks as well and is therefore available anyway. Suitable data carriers for providing the computer program are, in particular, magnetic, electrical, and optical data carriers such as hard disks, flash memories, EEPROM's, DVD's, and the like. A download of a program via computer networks (Internet, intranet, etc.) is also possible.

Further advantages and embodiments of the invention arise from the description and the accompanying drawing.

It is to be understood that the features mentioned above and below may be used not only in the particular combination specified, but also in other combinations or by themselves, without departing from the scope of the present invention.

The invention is schematically represented in the drawing using exemplary embodiments and will be described in detail below with reference to the drawing.

### DESCRIPTION OF FIGURES

FIG. 1 shows, schematically and in perspective, a process apparatus through which fluid flows designed as a plate heat exchanger, and which can be analyzed in accordance with a preferred embodiment of a method according to the invention.

FIG. 2 shows a preferred embodiment of a method according to the invention as a block diagram.

### DETAILED DESCRIPTION OF THE DRAWING

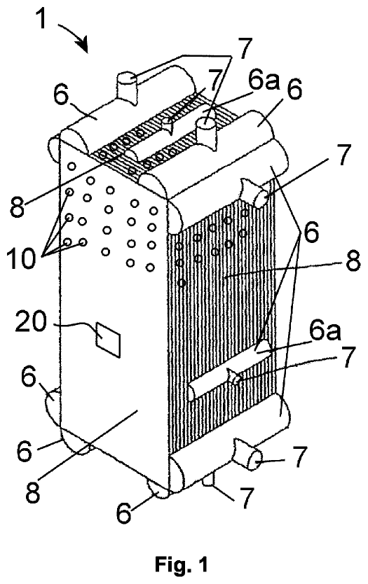

FIG. 1 shows an external view of a process apparatus here taking the form of plate heat exchanger 1.

A computing unit 20, designed, for example, as a control unit, is provided for controlling or regulating the plate heat exchanger. Furthermore, the plate heat exchanger 1 is equipped with a sufficient number of sensors 10, e.g., pressure and/or temperature sensors 10, for detecting measured values for the control or regulation.

The plate heat exchanger 1 has a cuboid central body 8 with a length of, for example, several meters and a width or height of, for example, approximately one or a few meters. Attachments 6 and 6a are visible on top of the central body 8, on its sides, and underneath the central body 8. The attachments 6 and 6a located underneath the central body 8 and on the side facing away from the side depicted are partially concealed.

A fluid or process stream can be supplied to or removed again from the plate heat exchanger 1 by connecting pieces 7. The attachments 6 and 6a serve for distributing the fluid introduced through the connecting pieces 7, or for collecting and concentrating the fluid to be removed from the plate heat exchanger 1. The various fluid streams then exchange thermal energy within the plate heat exchanger 1.

The plate heat exchanger 1 shown in FIG. 1 is designed to feed fluid streams past each other in separate passages for the purpose of heat exchange. Part of the streams can be guided past one another in opposite directions, another part crosswise or in the same direction.

The central body 8 is essentially an arrangement of separating plates, heat exchange profiles (so-called fins), and distributor profiles. For example, numerous profiles are arranged between and connected to two separating plates. Separating plates and layers with profiles alternate. A layer having a heat exchange profile and distributor profiles is called a passage.

At the sides of the plate heat exchanger 1, the distributor profiles have distributor profile accesses (so-called headers or half-shells). The fluid may be introduced through these from the outside into the associated passages via the attachments 6 and 6a and connecting pieces 7, or also removed again. The distributor profile accesses are concealed by the attachments 6 or 6a.

The central body 8 thus has passages and separating plates arranged to be alternately parallel to the flow directions. Both the separating plates and the passages are mostly made of aluminum. To their sides, the passages are closed off by side strips made of aluminum, so that a side wall is formed by the stacking design with the separating plates. The outside passages of the central body 8 are closed off by a cover made of aluminum (cover plate) lying parallel to the passages and the separating plates.

Such a central body 8 can be produced by, for example, applying a solder to the surfaces of the separating plates and then stacking the separating plates and the passages on top of each other alternately. The covers cover the stack 8 at the top or bottom. The central body is then soldered by heating in an oven.

During such soldering, a non-uniform temperature distribution within the central body 8 occurs during heating or cooling. Because of the different thermal expansions and the resulting deformation differences, this can lead to gap formations within the central body 8 due to loose or not yet sufficiently firmly connected profiles and separating plates. This can result in problems in the region of the insufficiently soldered layers in the case of later pressure samples. Thus, problems in the interior can occur on, for example, such a soldered block or central body 8 through the formation of dents due to insufficiently soldered areas.

In the framework of a preferred embodiment of the invention, a theoretical analysis of the plate heat exchanger 1 is to be carried out, e.g., in the course of a planning or design phase, in order to test various design variants of the plate heat exchanger 1 before construction and commissioning and to examine it for improvement potential. In particular, the plate heat exchanger 1 is to be examined in the course of this analysis as to whether and, if so, when an opening or breakage can occur in the form of the gap formations within the central body 8 due to loose or insufficiently connected layers lying on top of one another.

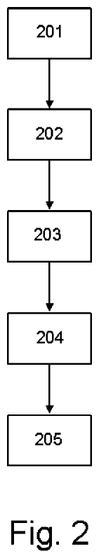

FIG. 2 shows a preferred embodiment of a method according to the invention as a block diagram.

In a step 201, a theoretical, numerical simulation of the plate heat exchanger 1 or at least part of the apparatus is carried out. For this purpose, a finite element method is carried out, in the course of which the plate heat exchanger 1 is subdivided into a plurality of individual sub-regions or finite elements, the physical or thermo-hydraulic behavior of which can be calculated on the basis of their simple geometry.

Individual instances of these finite elements are each part of a separating plate or a profile. The solder contact points between the separating plate and the profile are represented by finite contact elements.

In the course of conventional numerical simulations, such soldered joints can be numerically simulated with contact elements, by means of which the body contact and the transmission of the forces occurring in the process are computationally detected. However, this can be associated with considerable problems, since the nature of this calculation is non-linear, which can lead to convergence problems and computational terminations. In particular, the insoluble problem can occur here that, for acceptable accuracy, the contact tolerances should ideally be in the range of a few micrometers. However, deformations of the central body may be in the range of millimeters. This can lead to insurmountable hurdles in the course of the computational simulations.

Within the scope of the method, in step 202, the individual finite elements, which describe a soldered connection of two bodies, are each provided as a finite concrete contact element. The respective replacing concrete element is, in particular, adequate for the replaced element in terms of shape, volume, and mass, but, in contrast to the replaced contact element, is not made of solder, but rather of concrete as a material.

In step 203, a threshold value is set or predefined in the simulation. Concrete or concrete elements have, in particular, the property of transmitting compressive forces completely, but no or only slight tensile forces, because, otherwise, the concrete breaks. Up to the predefined threshold value, the concrete elements in the finite element simulation transmit tensile forces completely in each case. When the threshold value is reached, the concrete elements no longer transmit tensile forces, and the respective concrete element breaks.

Thus, in the finite element method, this predeterminable threshold value represents a breakage of the plate heat exchanger 1—in particular, the opening of a structure, viz., the opening or detachment of a passage or a profile from the separating plate, which occurs, in particular, during the heating or cooling of the central body 8.

The load limit at or above which the concrete element opens or breaks is adjustable.

In step 204, the finite element method is carried out according to the threshold values predetermined in step 203, and the plate heat exchanger 1 is numerically simulated. With the aid of this theoretical simulation, a load analysis of the plate heat exchanger 1 is carried out—in particular, a tension, deformation, and temperature field analysis.

In the course of this temperature field analysis, the uneven temperature distribution, in particular, in the central body 8 is simulated and analyzed, which occurs when the soldered connections of separating plates and passages are produced by heating and subsequent cooling. In the course of the tension and deformation analysis, the different thermal expansions in the central body 8 are simulated and analyzed, which may occur because of the uneven temperature distribution. Furthermore, the deformation differences in the central body 8 resulting from the different thermal expansions are simulated and analyzed.

In particular, it is simulated and analyzed in the course of this load analysis whether the selected design or dimensioning of the simulated plate heat exchanger ultimately results in a gap formation within the central body 8, i.e., in a breakage or loosening of the connection between separating plates and passages, due to the non-uniform temperature distribution, the different thermal expansions, and the deformation differences.

These finite element method results may be used in step 205 for the manufacture and commissioning of the plate heat exchanger 1, in order to avoid the occurrence of such breakages.

1. A method for the theoretical analysis of a process apparatus through which fluid flows,
wherein a theoretical—in particular, numerical—simulation of the apparatus or of at least one part of the apparatus is carried out,
wherein at least one element of the apparatus which does not feature concrete as a material is replaced in the theoretical simulation by at least one concrete element which is manufactured from concrete, and
wherein a load analysis of the apparatus is carried out with the aid of the theoretical simulation.

2. The method according to claim 1, wherein a finite element method is carried out as the theoretical simulation of the apparatus or at least one part of the apparatus, and the at least one element is a finite element.

3. The method according to claim 1, wherein the at least one element is at least one contact element through which forces are transmitted between adjacent elements.

4. The method according to claim 1, wherein the at least one element and the at least one concrete element have the same or at least substantially the same properties with regard to force transmission to adjacent elements.

5. The method according to claim 1, wherein the at least one concrete element has the property of transmitting compressive forces completely or at least substantially completely to at least one adjacent element.

6. The method according to claim 1, wherein the at least one concrete element has the property of transmitting tensile forces to at least one adjacent element up to a predeterminable threshold value.

7. The method according to claim 6, wherein the predeterminable threshold value represents a breakage of the apparatus—in particular, an opening of a structure.

8. The method according to claim 6, wherein the predeterminable threshold value
represents a leakage of a flange seal and/or
represents an opening of layers of the apparatus embodied as a plate heat exchanger and/or
represents an opening of a bundle—in particular, at a bundle end—of the apparatus embodied as a coil or wound heat exchanger.

9. The method according to claim 1, wherein a tension, deformation, and/or temperature field analysis of the apparatus is carried out as a load analysis.

10. The method according to claim 1, wherein the process apparatus through which fluid flows is designed as a heat exchanger—in particular, as a plate heat exchanger or coil or wound heat exchanger—or as a column or as a container for phase separation.

11. A computing unit with means for carrying out the method according to claim 1.

12. A computer program that causes a computing unit to carry out the method according to claim 1 when it is executed on the computing unit.

13. A machine-readable storage medium having the computer program according to claim 12 stored thereon.
